(19) United States
(12) Patent Application Publication
(10) Pub. No.: US 2026/0036068 A1
(43) Pub. Date: Feb. 5, 2026

(54) OVERLAP HOLDER FOR SEGMENTED LINER OF TURBOMACHINE COMPONENT

(71) Applicant: GE Vernova Infrastructure Technology LLC, Greenville, SC (US)

(72) Inventors: Robert Jamiolkowski, Warsaw (PL); Michal Badura, Warsaw (PL); Guenter Regnath, Baden (CH)

(21) Appl. No.: 19/282,396

(22) Filed: Jul. 28, 2025

(30) Foreign Application Priority Data
Aug. 1, 2024 (PL) P.449433

(51) Int. Cl. F01D 25/30

(52) U.S. Cl. CPC F01D 25/30; F05D 2260/31

(57) ABSTRACT

An overlap holder for a segmented liner of a turbomachine exhaust diffuser includes stacked plates and fasteners. A main plate includes a first face, an opposite second face, a first end, and an opposite second end. A spacer, which includes respective first and second faces, engages the first face of the main plate. A top plate includes a respective first face that engages the second face of the main plate and a respective second face opposite the first face of the top plate. A fastener is disposed at each of the first end and the second end of the main plate. Each fastener extends through holes in the spacer, the main plate, and the top plate to hold the spacer, the main plate, and the top plate in mutual engagement to secure a first segment of the segmented liner to an adjacent second segment of the segmented liner.

### CROSS-REFERENCE TO RELATED APPLICATION

This application claims priority pursuant to 35 U.S.C. 119 (a) to Polish Application No. P.449433, filed Aug. 1, 2024, which application is incorporated herein by reference in its entirety.

### TECHNICAL FIELD

The disclosure relates generally to turbomachine components, such as exhaust gas diffusers and, more particularly, to a holder for overlapping liner segments thereof.

### BACKGROUND

A turbomachine, particularly a gas turbine engine, generally includes an inlet arrangement, a compressor section, a combustion section, a turbine section (i.e., an expansion turbine), and an exhaust system. Typically, an exhaust system will include an exhaust gas diffuser, which directs exhaust gases expelled by the turbine section away from the turbomachine. An exhaust gas diffuser can include an outer casing and a segmented liner that forms an inner casing, when assembled. For example, some segmented liners have segments that extend most or all of the length of the diffuser and that are joined on edges parallel to the rotational axis of the turbine. The joined edges can be held together in various ways. One holder arrangement uses simple tabs attached to overlapping liner segment portions, but such simple tabs can experience cracking and wear because of uneven load distribution, partly due to thermal expansion of the components.

### SUMMARY

All aspects, examples and features mentioned below can be combined in any technically possible way.

In summary, stacked plates and fasteners form an overlap holder to bias overlapping liner segments together. The liner segments can define an inner surface of an exhaust diffuser of a turbomachine. A spacer rests on a lower tongue of one segment and supports a main plate engaging an upper tongue of another segment that partly overlies the lower tongue. A top plate rests on the main plate. Bolts extend through the lower tongue, spacer, main plate, top plate, and (optionally) a tab washer on the top plate. The assembly is drawn together by nuts on the tab washer. A vertical plate welded to the lower tongue extends through slots in the plates between the bolts, holding the plates together and providing additional stiffness.

More specifically, an aspect of the disclosure provides an overlap holder for a segmented liner of a turbomachine exhaust diffuser, comprising: a main plate with a first face and a second face opposite the first face, and wherein the main plate has a first end and a second end opposite the first end; a spacer with a respective first face and a respective second face opposite the first face of the spacer and that engages the first face of the main plate; a top plate with a respective first face and a respective second face opposite the first face of the top plate, wherein the first face of the top plate engages the second face of the main plate; and a respective fastener at each of the first end and the second end of the main plate, each fastener extending through respective holes in the spacer, the main plate, and the top plate, wherein respective ends of each fastener are adjacent the first face of the spacer and the second face of the top plate, the respective fastener holding the spacer, the main plate, and the top plate in mutual engagement to secure a first segment of the segmented liner to an adjacent second segment of the segmented liner.

Another aspect of the disclosure includes any of the preceding aspects, and further comprising a tab washer adjacent the top plate at each fastener, the tab washer engaging the top plate and a respective end of the fastener adjacent the top plate, thereby preventing rotation of each respective fastener relative to the top plate.

Another aspect of the disclosure includes any of the preceding aspects, and further comprising a weld securing each tab washer to the respective fastener.

Another aspect of the disclosure includes any of the preceding aspects, and wherein each fastener is a bolt with a head at a first end and a nut at second end opposite the first end, and the weld securing each tab washer to the respective fastener is between the tab washer and the respective nut.

Another aspect of the disclosure includes any of the preceding aspects, and further comprising a weld securing the top plate to the main plate.

Another aspect of the disclosure includes any of the preceding aspects, and wherein the main plate is sized to engage an upper tongue of the first segment of the segmented liner, wherein the upper tongue is configured to overlie a lower tongue of the adjacent second segment of the segmented liner, and an end of each fastener is configured to engage the lower tongue such that, when assembled, the main plate and the respective end of each fastener bias the upper tongue and the lower tongue toward each other.

Another aspect of the disclosure includes any of the preceding aspects, and wherein the thickness of the spacer is selected to match a thickness of the upper tongue.

Another aspect of the disclosure includes any of the preceding aspects, and wherein the spacer the upper tongue define a gap therebetween.

Another aspect of the disclosure includes any of the preceding aspects, and further comprising a vertical plate disposed along a length of the main plate, the spacer, and the top plate between the fasteners, wherein the vertical plate extends through the main plate, the spacer, and the top plate via respective lengthwise slots formed therethrough.

Another aspect of the disclosure includes any of the preceding aspects, and further comprising a weld between the vertical plate and at least one of the top plate, the tab washer, or the spacer.

An aspect of the disclosure provides a segmented liner for an exhaust diffuser of a turbomachine, the segmented liner comprising: a plurality of liner segments collectively defining an inner surface of the exhaust diffuser and including a first segment having an upper tongue at the first radial distance from a rotational axis of the turbomachine and a second segment having a lower tongue at a second radial distance that is larger than the first radial distance such that the upper tongue overlies the lower tongue. An overlap holder couples the first liner segment to the second liner segment. The overlap holder can include: a main plate with a first face and a second face opposite the first face, wherein the main plate has a first end and a second end opposite the first end, and wherein the first face of the main plate engages the upper tongue; a spacer with a respective first face and a respective second face opposite the first face of the spacer, wherein the first face of the spacer engages the lower tongue, and the second face of the spacer engages the first face of the main plate; a top plate with a respective first face and a respective second face opposite the first face of the top plate, wherein the first face of the top plate engages the second face of the main plate; and a respective fastener at each of the first end and the second end of the main plate, each fastener extending respective holes in the spacer, the main plate, and the top plate, wherein a respective end of each fastener is adjacent one of the first face of the spacer or the second face of the top plate, the respective fastener holding the spacer, the main plate, and the top plate in mutual engagement, wherein the spacer and the upper tongue define a gap therebetween in at least the circumferential direction.

Another aspect of the disclosure includes any of the preceding aspects, and further comprising a tab washer adjacent the top plate at each fastener, the tab washer engaging the top plate and a respective end of each fastener adjacent the top plate, thereby preventing rotation of each respective fastener relative to the top plate, the tab washer engaging the top plate and the respective end of each fastener adjacent the top plate, thereby preventing rotation of each respective fastener relative to the top plate.

Another aspect of the disclosure includes any of the preceding aspects, and wherein the fastener is a bolt with a head adjacent one of the lower tongue or the top plate, wherein the bolt has a nut adjacent the other of the lower tongue or the top plate, and the tab washer engages the one of the head or the nut that is adjacent the top plate.

Another aspect of the disclosure includes any of the preceding aspects, and further comprising a weld between the nut and the bolt.

Another aspect of the disclosure includes any of the preceding aspects, and wherein the main plate and the respective end of each fastener bias the upper tongue and the lower tongue toward each other.

Another aspect of the disclosure includes any of the preceding aspects, and wherein a thickness of the spacer is selected to match a thickness of the upper tongue.

Another aspect of the disclosure includes any of the preceding aspects, and wherein the gap between the spacer and the upper tongue is at least partly defined by a profile of the upper tongue corresponding to a cutout in the upper tongue.

Another aspect of the disclosure includes any of the preceding aspects, and further comprising a vertical plate disposed along a length of the spacer, the main plate, and the top plate between the fasteners, wherein the vertical plate extends through the spacer, the main plate, and the top plate via respective lengthwise slots formed therethrough.

Another aspect of the disclosure includes any of the preceding aspects, and further comprising a weld between the vertical plate and the top plate.

Another aspect of the disclosure includes any of the preceding aspects, and further comprising a weld between the vertical plate and at least one of the spacer or the lower tongue.

Two or more aspects described in this disclosure, including those described in this summary section, may be combined to form implementations not specifically described herein.

The details of one or more implementations are set forth in the accompanying drawings and the description below. Other features, objects and advantages will be apparent from the description and drawings, and from the claims.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 is a schematic diagram of a turbomachine, such as a gas turbine engine, in which an overlap holder according to embodiments of the disclosure can be employed;

FIG. 2 is a perspective view of a portion of an interior of an exhaust gas diffuser with a segmented liner according to embodiments of the disclosure, in which overlap holders of the present disclosure are used to hold liner segments together;

FIG. 3 is an enlarged elevation view of an overlap holder, such as is shown in FIG. 2, according to embodiments of the disclosure;

FIG. 4 shows a cross section of an overlap holder of FIG. 3 in a circumferential-radial plane, taken along line A-A of FIG. 3, according to embodiments of the disclosure; and,

FIG. 5 shows a cross section of the overlap holder of FIG. 3 in an axial-radial plane, taken along line B-B of FIG. 3, according to embodiments of the disclosure.

It is noted that the drawings of the disclosure are not necessarily to scale. The drawings are intended to depict only typical aspects of the disclosure and therefore should not be considered as limiting the scope of the disclosure. In the drawings, like numbering represents like elements between the drawings.

### DETAILED DESCRIPTION OF THE INVENTION

As an initial matter, in order to clearly describe the current disclosure, it will become necessary to select certain terminology when referring to and describing relevant machine components within the illustrative application of a segmented liner for a turbomachine exhaust gas diffuser. When doing this, if possible, common industry terminology will be used and employed in a manner consistent with its accepted meaning. Unless otherwise stated, such terminology should be given a broad interpretation consistent with the context of the present application and the scope of the appended claims. Those of ordinary skill in the art will appreciate that often a particular component may be referred to using several different or overlapping terms. What may be described herein as being a single part may include and be referenced in another context as consisting of multiple components. Alternatively, what may be described herein as including multiple components may be referred to elsewhere as a single part.

In addition, several descriptive terms may be used regularly herein, and it should prove helpful to define these terms at the onset of this section. These terms and their definitions, unless stated otherwise, are as follows. As used herein, “downstream” and “upstream” are terms that indicate a direction relative to the flow of a fluid, such as the working fluid through the turbomachine or, for example, the flow of exhaust through an exhaust diffuser. The term “downstream” corresponds to the direction of flow of the fluid, and the term “upstream” refers to the direction opposite to the flow. The terms “forward” and “aft,” without any further specificity, refer to directions, with “forward” or “fore” referring to the front or compressor end of the turbomachine, and “aftward” or “aft” referring to the rearward or turbine end of the turbomachine.

It is often required to describe parts that are at different radial positions with regard to a center axis. The term “axial” refers to movement or position parallel to an axis, e.g., an axis of a turbomachine or exhaust diffuser thereof. The term “radial” refers to movement or position perpendicular to an axis, e.g., an axis of a turbomachine or exhaust diffuser. In cases such as this, if a first component resides closer to the axis than a second component, it will be stated herein that the first component is “radially inward” or “inboard” of the second component. If, on the other hand, the first component resides further from the axis than the second component, it may be stated herein that the first component is “radially outward” or “outboard” of the second component. Finally, the term “circumferential” refers to movement or position around an axis, e.g., a circumferential interior surface of an exhaust diffuser. As indicated above, it will be appreciated that such terms may be applied in relation to the axis of the turbomachine or the axis of an exhaust diffuser.

In addition, several descriptive terms may be used regularly herein, as described below. The terms “first,” “second,” and “third,” may be used interchangeably to distinguish one component from another and are not intended to signify location or importance of the individual components.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event or circumstance may or may not occur or that the subsequently described component or element may or may not be present and that the description includes instances where the event occurs, or the component is present and instances where the event does not occur, or the component is not present.

Where an element or layer is referred to as being “on,” “engaged to,” “connected to,” “coupled to,” or “mounted to” another element or layer, it may be directly on, engaged, connected, coupled, or mounted to the other element or layer, or intervening elements or layers may be present. In contrast, when an element is referred to as being “directly on,” “directly engaged to,” “directly connected to,” or “directly coupled to” another element or layer, no intervening elements or layers are present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items. The verb forms of “couple” and “mount” may be used interchangeably herein.

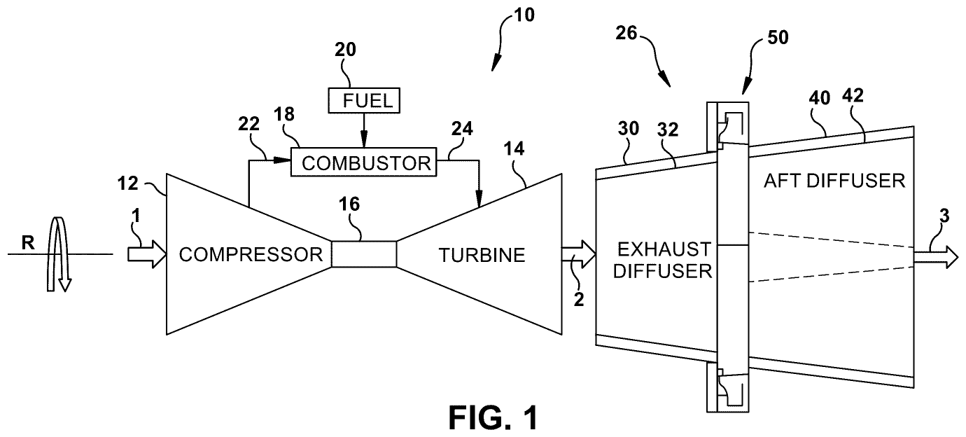

Embodiments of the disclosure can be implemented in a component of a turbomachine 10 as illustrated in FIG. 1. Turbomachine 10 can include a compressor 12, a turbine 14 (i.e., an expansion turbine), and a shaft 16 supporting blades of compressor 12 and turbine 14. A combustor 18 can be in fluid communication with compressor 12 and turbine 14 and can receive fuel from a fuel supply 20. Inlet air 1 can be supplied to compressor 12, which can supply compressed air 22 to combustor 18 to form a mixture with fuel from fuel supply 20, which is burned in combustor 18 to form hot gas 24. Hot gas 24 can be directed to turbine 14, which can extract work from hot gas 24 to rotate shaft 16 about rotational axis R (i.e., a circumferential direction relative to shaft 16). Hot gas 24 can exit turbine 14 as exhaust gas 2 and enter one or more components of an exhaust system 26. For example, exhaust system 26 can include an exhaust gas diffuser 30, which can include a segmented liner 32. Some exhaust systems 26 can also include an aft diffuser 40, which could include another segmented liner 42. Aft diffuser 40 can be connected to exhaust gas diffuser 30 by an expansion joint 50 or the like. Expanded gases 3 are directed from the exhaust system 26 to an exhaust stack (not shown) or to a heat recovery steam generator (not shown), the latter being used in a combined cycle power plant.

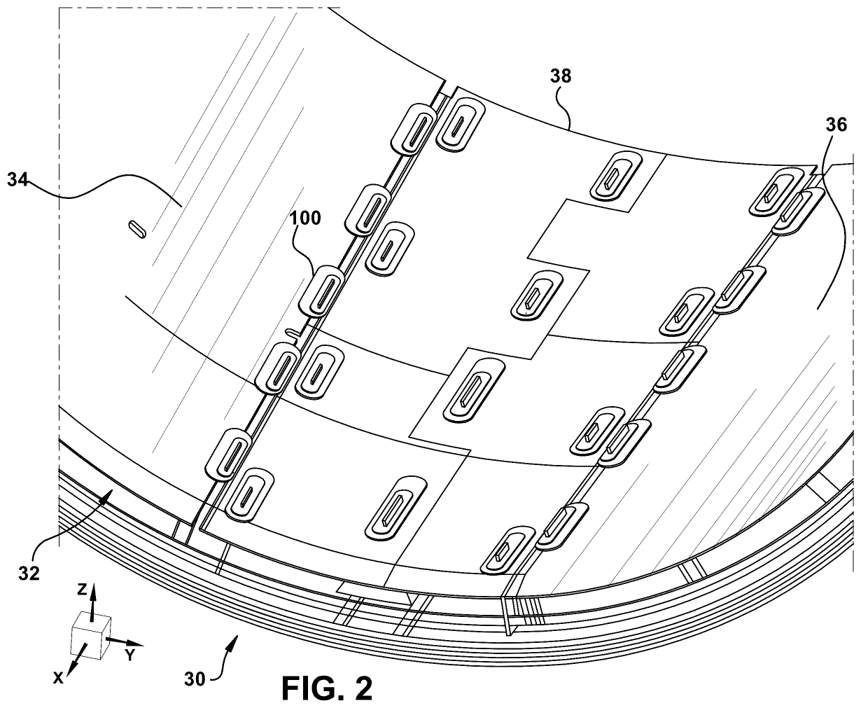

Turning now to FIG. 2, a set of axes X, Y, and Z is provided to illustrate orientation of the parts shown: X axis illustrates the axial direction, Y illustrates the circumferential direction, and Z illustrates the radial direction. A segmented liner 32 can include segments, such as left segment 34, right segment 36, and bottom segment 38, held together with various hardware. Segmented liner 32 when assembled can resemble a frustoconical shell divided into segments. Each segment can have at least a portion of the axial extent of segmented liner 32. Each segment can also have an arcuate extent that is a portion of the circumferential extent of segmented liner 32. In addition, some segments may themselves be segmented axially, circumferentially, or both, as with bottom segment 38 in FIG. 2. Thus, if segmented liner 32 is divided into twelve equal segments each with the full axial length of segmented liner 32, each segment will have an arcuate extent of 30° and will be narrower at one end than the other so that the assembled segmented liner 32 is frustoconical with a full 360° circumferential extent. As shown in FIG. 1, the end with the smaller diameter (i.e., the narrower end) is the upstream end in closest proximity to the turbine 14, while the end with the larger diameter (i.e., the wider end) is the downstream end in closest proximity to the exit of the exhaust system 26.

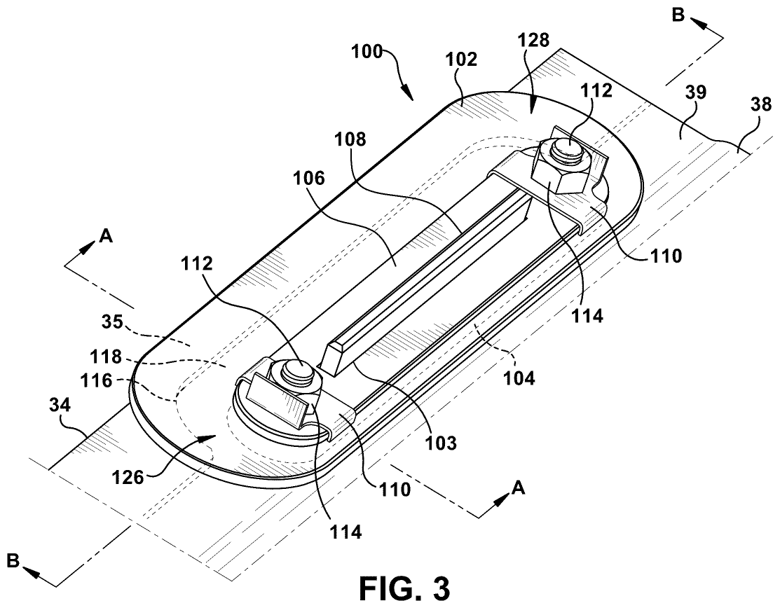

Some segments can be held together with overlap holders 100 according to embodiments disclosed herein. For example, with additional reference to FIG. 3, a first segment, such as left segment 34, can include an upper tongue 35; and a second segment, such as bottom segment 38, can include a lower tongue 39. It should be noted that for convenience, components of embodiments of the disclosure are described as being “upper” or “lower,” but these can also be termed “radially inner” and “radially outer,” respectively, since the segments are distributed around a longitudinal axis of exhaust diffuser 30, which may be parallel to or coaxial with axis of rotation R (FIG. 1). In some segmented liners, the second segment can be a bottom segment 38 that can include lower tongues 39 along circumferentially opposite edges of bottom segment 38. This can allow edges of the segments to overlap in a fashion similar to roof shingles, where the tongue of a low edge of a segment lies over the tongue of a high edge of the next lower segment so that, for example, liquids can be diverted to the lowest segment for handling. In FIG. 2, upper tongues (not shown) are formed on lower edges of left and right segments 34, 36, while lower tongues (not shown) are formed on edges of bottom segment 38. Thus, segmented liner 32 can extend circumferentially around an inner surface of a component of turbomachine 10, such as exhaust gas diffuser 30, at a first radial distance from a rotational axis R (FIG. 1) of turbomachine 10. Segmented liner 32 can include a first segment, such as left segment 34, having an upper tongue 35 at the first radial distance and a second segment, such as bottom segment 38, having a lower tongue 39 at a second radial distance that is larger than the first radial distance such that upper tongue 35 overlies lower tongue 39.

Overlap holder 100 can employ multiple plates in a sandwich like assembly that can improve distribution of loads on welds included in segmented liner 32 and overlap holder 100. Fasteners, such as bolts, can be used to close possible gaps that might be left by simply welding one plate onto overlapping segment edges. Use of such fasteners can help during final welding and can eliminate the need for special tooling. In addition, such fasteners can add stiffness to the system, reducing vibration of the plates during operation. Tab washers can be included to inhibit rotation of nuts on the fasteners while allowing movement of components due to thermal expansion.

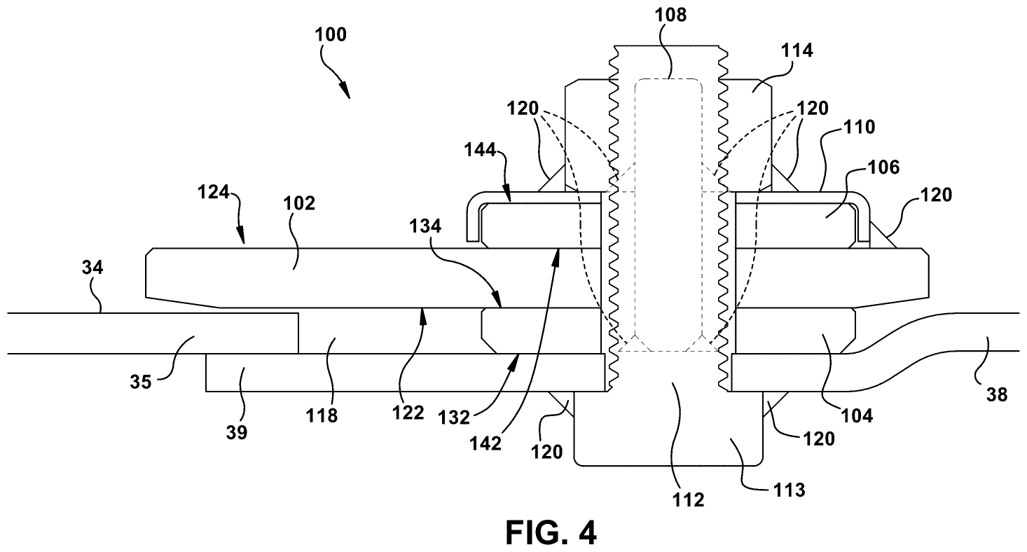

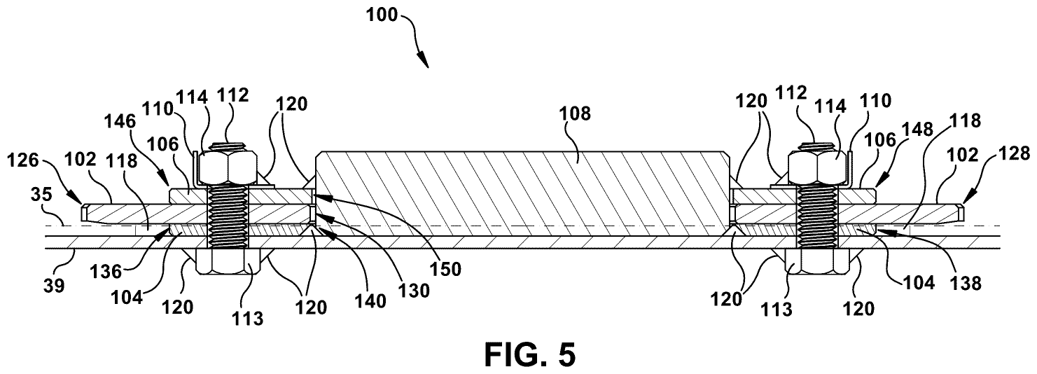

An enlarged view of overlap holder 100 for a segmented liner of a turbomachine component is shown in FIG. 3. With additional reference to FIG. 4, overlap holder 100 can include a main plate 102 with a first face 122, such as a lower face, and a second face 124, such as an upper face, so that second face 124 is opposite first face 122 with a thickness of main plate 102 therebetween. As shown in FIG. 5, main plate 102 can also have a first end 126 and a second end 128 opposite first end 126 with a length of main plate 102 therebetween.

Overlap holder 100 can also include a spacer 104 with a respective first face 132 and a respective second face 134, wherein second face 134 is opposite first face 132 of spacer 104 with a thickness of spacer 104 therebetween. As with main plate 102, first face 132 can be a lower face of spacer 104 and second face 134 can be an upper face of spacer 104 as shown. In embodiments, second face 134 of spacer 104 engages first face 122 of main plate 102. As shown in FIG. 5, spacer 104 can also have a respective first end 136 and a respective second end 138 opposite first end 136 with a length of spacer 104 therebetween.

In addition, overlap holder 100 can include a top plate 106 with a respective first face 142, such as a lower face thereof, and a respective second face 144, such as an upper face thereof. Thus, second face 144 is opposite first face 142 of top plate 106 with a thickness of top plate 106 therebetween. As shown in FIG. 5, with main plate 102 and spacer 104, top plate 106 can have a respective first end 146 and a respective second end 148 opposite first end 146 with a length of top plate 106 therebetween. In embodiments, first face 142 of top plate 106 can engage second face 124 of main plate 102.

As seen in FIGS. 3-5, overlap holder 100 can include a respective fastener 112 at each of first end 126 and second end 128 of main plate 102. For example, each fastener 112 can be a bolt with a respective head 113 on one end and a respective nut 114 on an opposite end. Each fastener 112 can extend through respective holes in main plate 102, spacer 104, and top plate 106, wherein respective ends of each fastener 112 are adjacent first face 132 of spacer 104 and second face 144 of top plate 106. In this way, fasteners 112 can hold top plate 106, main plate 102, and spacer 104 in mutual engagement. In addition, as particularly seen in FIG. 4, first face 122 of main plate 102 is configured to and can engage upper tongue 35 of first segment 34, and first face 132 of spacer 104 is configured to and can engage lower tongue 39 of second segment 38. When the upper and lower tongues 35, 39 are engaged, fasteners 112 cooperate with top plate 106, main plate 102, and spacer 104 to force upper tongue 35 and lower tongue 39 together.

As noted above, fastener 112 can be a bolt with a head 113 adjacent one of lower tongue 39 or top plate 102, in which case the bolt has a nut 114 adjacent the other of lower tongue 39 or top plate 106. Overlap holder 100 can also include an anti-rotation device, such as a tab washer 110, adjacent top plate 106 that can engage head 113 and/or nut 114, as well as top plate 106. Thus, tab washer 110 can engage the one of head 113 or nut 114 that is adjacent top plate 106, as well as top plate 106, thereby preventing rotation of head 113 and/or nut 114 relative to top plate 106. In the example shown, tab washers 110 engage nuts 114 of first and second bolts 112. In addition, a weld 120 can be included between each nut 114 and respective tab washer 110, and/or between one or more nuts 114 and one or more respective bolts 112. Welds 120 can be used to secure heads 113 of bolts to lower tongue 39 (FIG. 5), nuts 114 to tab washers 110 (FIGS. 4 and 5) and/or top plate 106, and nuts 114 to bolts 112 (not shown).

To enable operation of overlap holder 100, main plate 102 is sized to engage upper tongue 35 of first segment 34 of segmented liner 32, as suggested above. Upper tongue 35 overlies lower tongue 39 of second segment 38 of segmented liner 32, and an end of each fastener 112 is configured to engage lower tongue 39. For example, where fastener 112 is a bolt, head 113 can engage lower tongue 39, though some embodiments could instead have nut 114 engage lower tongue 39. Main plate 102 and the respective end of each fastener 112 can thereby bias upper tongue 35 and lower tongue 39 toward each other. In particular embodiments, as shown in FIGS. 4 and 5, a thickness of spacer 104 is selected to match a thickness of upper tongue 35 so that inner surfaces of first and second segments, such as left segment 34 and bottom segment 38, can be flush and to increase engagement between first surface 122 of main plate 102 and upper tongue 35. In addition, a width of spacer can be selected to provide a gap 118 between spacer 104 and upper tongue 35. In addition, or alternatively, gap 118 can be defined by spacer 104 and a cutout 116 (FIG. 3) in upper tongue 35. In any case, gap 118 can be defined between upper tongue 35 and spacer 104 to allow for thermal expansion of components.

As particularly seen in FIG. 5, overlap holder 100 can include a vertical plate 108 disposed along the length of main plate 102 between fasteners 112. Vertical plate 108 can extend from lower tongue 39 and can extend through main plate 102, spacer 104, and top plate 106 via respective lengthwise slots 130, 140, 150 formed therethrough. In embodiments, as seen in FIGS. 4 and 5, one or more welds 120 can be formed between vertical plate 108 and spacer 104, top plate 106, tab washer 110, and/or lower tongue 39. Vertical plate 108 can thereby contribute to holding top plate 106, main plate 102, spacer 104, upper tongue 35, and lower tongue 39 together.

Embodiments of the disclosure provide various technical and commercial advantages, examples of which are discussed herein. The technical effect of an overlap holder 100 according to embodiments of the disclosure is to connect segments of a liner for a turbomachine component, such as an exhaust gas diffuser. Liner segments so connected can divert liquid to a bottom segment, which can include a drain or the like to remove fluid from within the liner and component in which it is installed. Cutouts in the segment tongues can provide gaps between the tongues and parts of the overlap holder to allow for thermal expansion of liner segments, overlap holder components, and/or other components.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise. “Approximately” or “about,” as applied to a particular value of a range, applies to both end values and, unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiments were chosen and described to best explain the principles of the disclosure and the practical application of such technology and to enable others of ordinary skill in the art to understand the various embodiments of the present disclosure and the possibility of various modifications of the disclosed embodiments, as may be suited to the particular use(s) contemplated.

What is claimed is:

1. An overlap holder for a segmented liner of a turbomachine exhaust diffuser, comprising:
a main plate with a first face and a second face opposite the first face, and wherein the main plate has a first end and a second end opposite the first end;
a spacer with a respective first face and a respective second face opposite the first face of the spacer, wherein the spacer engages the first face of the main plate;
a top plate with a respective first face and a respective second face opposite the first face of the top plate, wherein the first face of the top plate engages the second face of the main plate; and,
a fastener at each of the first end and the second end of the main plate, each fastener extending through respective holes in the spacer, the main plate, and the top plate, the respective fastener holding the spacer, the main plate, and the top plate in mutual engagement to secure a first segment of the segmented liner to an adjacent second segment of the segmented liner.

2. The overlap holder of claim 1, further comprising a tab washer adjacent the top plate at each fastener, the tab washer engaging the top plate and a respective end of the fastener adjacent the top plate, thereby preventing rotation of each respective fastener relative to the top plate.

3. The overlap holder of claim 2, further comprising a weld securing each tab washer to the respective fastener.

4. The overlap holder of claim 3, wherein each fastener is a bolt with a head at a first end and a nut at a second end opposite the first end of the bolt, and the weld securing each tab washer to the respective fastener is between the tab washer and the respective nut.

5. The overlap holder of claim 1, further comprising a weld securing the top plate to the main plate.

6. The overlap holder of claim 1, wherein the main plate is sized to engage an upper tongue of the first segment of the segmented liner, wherein the upper tongue is configured to overlie a lower tongue of the adjacent second segment of the segmented liner, and an end of each fastener is configured to engage the lower tongue such that, when assembled, the main plate and the respective end of each fastener bias the upper tongue and the lower tongue toward each other.

7. The overlap holder of claim 6, wherein a thickness of the spacer is selected to match a thickness of the upper tongue.

8. The overlap holder of claim 6, wherein the spacer and the upper tongue define a gap therebetween.

9. The overlap holder of claim 1, further comprising a vertical plate disposed along a length of the main plate, the spacer, and the top plate between the fasteners, wherein the vertical plate extends through the main plate, the spacer, and the top plate via respective lengthwise slots formed through the main plate, the spacer, and the top plate.

10. The overlap holder of claim 9, further comprising a weld between the vertical plate and at least one of the top plate, the tab washer, or the spacer.

11. A segmented liner for an exhaust diffuser of a turbomachine, the segmented liner comprising:
a plurality of liner segments collectively defining an inner surface of the exhaust diffuser and including a first segment having an upper tongue at a first radial distance from a rotational axis of the turbomachine and a second segment having a lower tongue at a second radial distance that is larger than the first radial distance such that the upper tongue overlies the lower tongue; and
an overlap holder coupling the first segment to the second segment, the overlap holder comprising:
a main plate with a first face and a second face opposite the first face, wherein the main plate has a first end and a second end opposite the first end, and wherein the first face of the main plate engages the upper tongue;
a spacer with a respective first face and a respective second face opposite the first face of the spacer, wherein the first face of the spacer engages the lower tongue, and the second face of the spacer engages the first face of the main plate;
a top plate with a respective first face and a respective second face opposite the first face of the top plate, wherein the first face of the top plate engages the second face of the main plate; and,
a fastener at each of the first end and the second end of the main plate, each fastener extending through respective holes in the spacer, the main plate, and the top plate, the respective fastener holding the spacer, the main plate, and the top plate in mutual engagement, wherein the spacer and the upper tongue define a gap therebetween in at least the circumferential direction.

12. The segmented liner of claim 11, wherein the overlap holder further comprises a tab washer adjacent the top plate at each fastener, the tab washer engaging the top plate and a respective end of each fastener adjacent the top plate, thereby preventing rotation of each respective fastener relative to the top plate, the tab washer engaging the top plate and the respective end of each fastener adjacent the top plate, thereby preventing rotation of each respective fastener relative to the top plate.

13. The segmented liner of claim 12, wherein the fastener is a bolt with a head adjacent one of the lower tongue or the top plate, wherein the bolt has a nut adjacent the other of the lower tongue or the top plate, and the tab washer engages the one of the head or the nut that is adjacent the top plate.

14. The segmented liner of claim 13, further comprising a weld between the nut and the tab washer.

15. The segmented liner of claim 12, wherein the main plate and the respective end of each fastener bias the upper tongue and the lower tongue toward each other.

16. The segmented liner of claim 11, wherein a thickness of the spacer is selected to match a thickness of the upper tongue.

17. The segmented liner of claim 11, wherein the gap between the spacer and the upper tongue is at least partly defined by a profile of the upper tongue corresponding to a cutout in the upper tongue.

18. The segmented liner of claim 11, further comprising a vertical plate disposed along a length of the main plate, the spacer, and the top plate between the fasteners, wherein the vertical plate extends through the spacer, the main plate, and the top plate via respective lengthwise slots formed through the spacer, the main plate, and the top plate.

19. The segmented liner of claim 18, further comprising a weld between the vertical plate and the top plate.

20. The segmented liner of claim 16, further comprising a weld between the vertical plate and at least one of the spacer or the lower tongue.
